(19) United States
(12) Patent Application Publication
(10) Pub. No.: US 2017/0255985 A1
(43) Pub. Date: Sep. 7, 2017

(54) RECOMMENDATION ENGINE

(71) Applicant: eBay Inc., San Jose, CA (US)

(72) Inventors: Troy Steven Acott, Beaverton, OR (US); Jesse Block, Portland, OR (US); Isaac Sachs, Portland, OR (US); Lucas DeShazer, Portland, OR (US)

(21) Appl. No.: 15/060,301

(22) Filed: Mar. 3, 2016

(51) Int. Cl. G06Q 30/06; G06F 3/0484; G06F 3/0482

(52) U.S. Cl. CPC G06Q 30/0631; G06Q 30/0643; G06F 3/0482; G06F 3/04842

(57) ABSTRACT

A user interacts with item listing while shopping for a gift for an intended recipient. Based on the user interactions, a recommendation engine selects item listings describing items for sale for presentation to the user, the item listings being for items of interest to the intended recipient. The selection is based on interactions by the user with item listings (e.g., past purchases by the user), attributes of the selected item listings, a wish list of the intended recipient, and behavior of other users. A recommendation may also be presented based on a date of an occasion for which an item may be purchased by the user as a gift for the intended recipient.

### TECHNICAL FIELD

The subject matter disclosed herein generally relates to computer systems that make recommendations. Specifically, the present disclosure addresses systems and methods related to the recommendation of items for purchase.

### BACKGROUND

The search and purchase history of a user are used to identify other items that may be of interest to the user. One or more recommended items are presented to the user.

### BRIEF DESCRIPTION OF THE DRAWINGS

Some embodiments are illustrated, by way of example and not limitation, in the figures of the accompanying drawings.

FIG. 1 is a network diagram illustrating a network environment suitable for generating recommendations, according to some example embodiments.

FIG. 2 is a block diagram illustrating components of a recommendation server suitable for generating recommendations, according to some example embodiments.

FIG. 3 is a block diagram illustrating a user interface suitable for displaying an item listing, according to some example embodiments.

FIG. 4 is a block diagram illustrating a user interface suitable for identifying an intended recipient of an item in an item listing, according to some example embodiments.

FIG. 5 is a block diagram illustrating a user interface suitable for identifying an occasion associated with an item for an intended recipient, according to some example embodiments.

FIG. 6 is a block diagram illustrating a user interface suitable for identifying a date associated with an occasion, according to some example embodiments.

FIG. 7 is a block diagram illustrating a user interface suitable for displaying sets of recommended item listings associated with different recipients, according to some example embodiments.

FIG. 8 is a block diagram illustrating a user interface suitable for displaying sets of recommended item listings associated with different occasions, according to some example embodiments.

FIG. 9 is a block diagram illustrating a user interface suitable for identifying an intended recipient of an item in an item listing, according to some example embodiments.

FIG. 10 is a block diagram illustrating a user interface suitable for presenting upcoming gift-giving events, according to some example embodiments.

FIG. 11 is a block diagram illustrating a user interface suitable for gathering additional information regarding an item recipient, according to some example embodiments.

FIG. 12 is a flowchart illustrating operations of a server in performing a process of generating recommendations, according to some example embodiments.

FIG. 13 is a flowchart illustrating operations of a server in performing a process of generating recommendations, according to some example embodiments.

FIG. 14 is a block diagram illustrating an example of a software architecture that may be installed on a machine, according to some example embodiments.

FIG. 15 illustrates a diagrammatic representation of a machine in the form of a computer system within which a set of instructions may be executed for causing the machine to perform any one or more of the methodologies discussed herein, according to an example embodiment.

### DETAILED DESCRIPTION

Example methods and systems are directed to generating recommendations for item listings. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

A recommendation engine selects item listings describing items for sale for presentation to a user. The selection is based on interactions by the user with item listings (e.g., past purchases by the user), attributes of the selected item listings, and behavior of other users.

The recommendation engine determines an intended recipient for one or more of the items in listings interacted with by the user. In some example embodiments, the intended recipient is assumed to be the user unless an indication to the contrary is received.

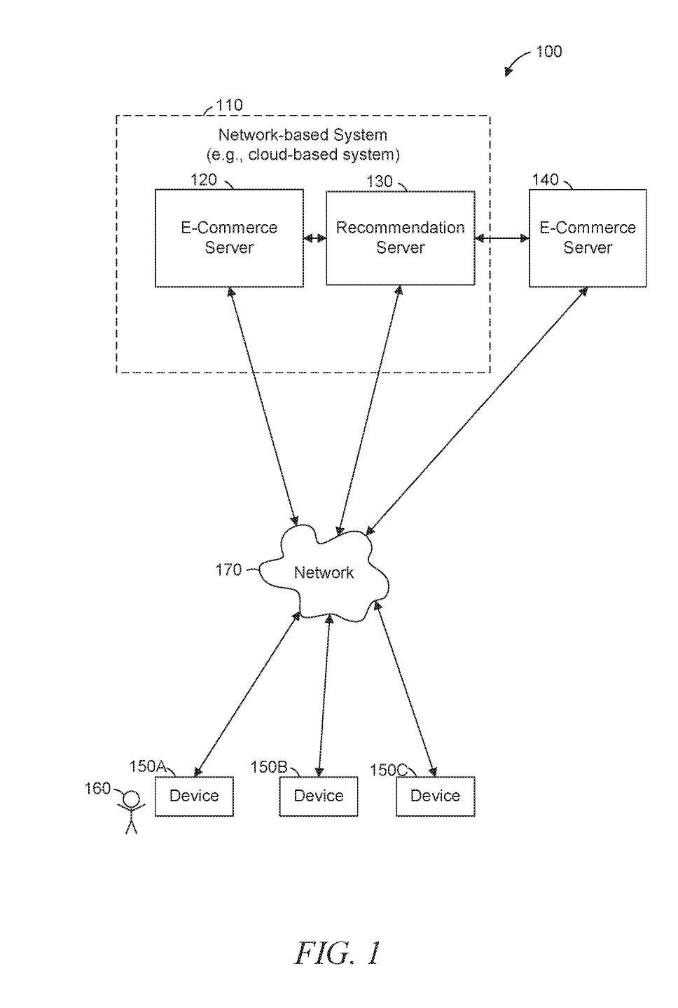

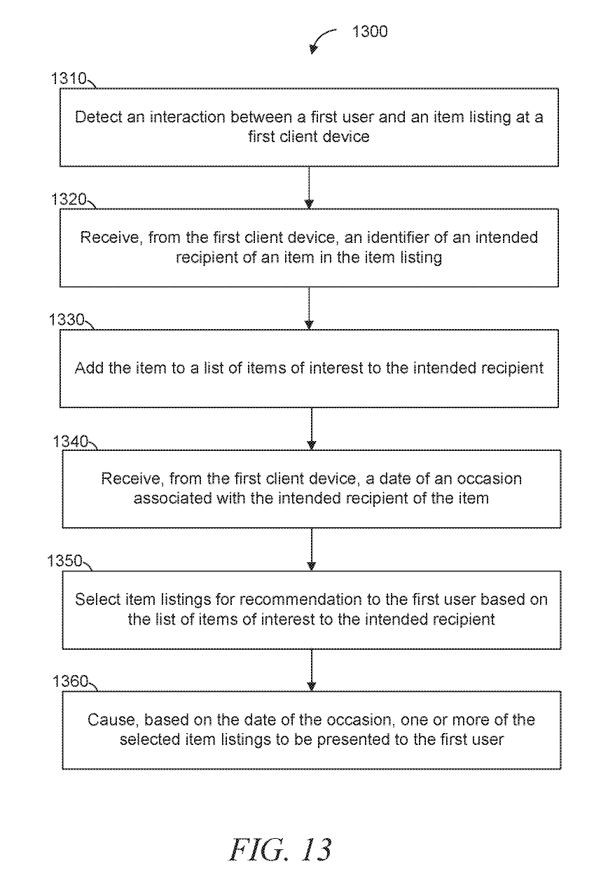

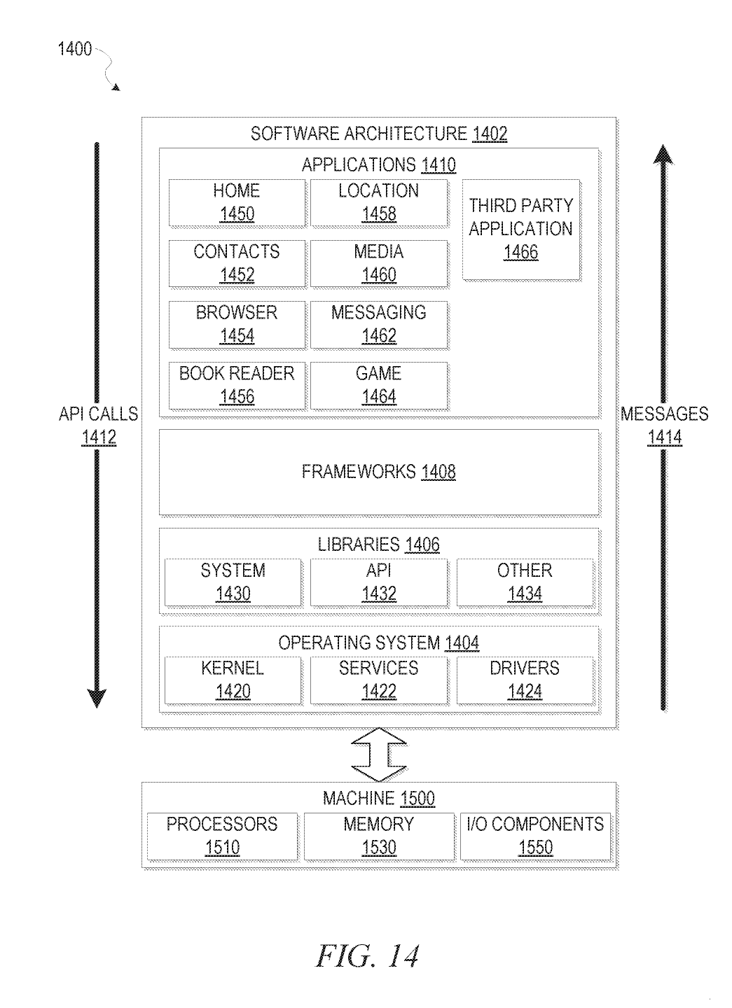

FIG. 1 is a network diagram illustrating a network environment 100 suitable for generating item recommendations, according to some example embodiments. The network environment 100 includes e-commerce servers 120 and 140, a recommendation server 130, and devices 150A, 150B, and 150C, all communicatively coupled to each other via a network 170. The devices 150A, 150B, and 150C may be collectively referred to as “devices 150,” or generically referred to as a “device 150.” The e-commerce server 120 and the recommendation server 130 may be part of a network-based system 110. Alternatively, the devices 150 may connect to the recommendation server 130 directly or over a local network distinct from the network 170 used to connect to the e-commerce server 120 or 140. The e-commerce servers 120 and 140, the recommendation server 130, and the devices 150 may each be implemented in a computer system, in whole or in part, as described below with respect to FIGS. 13-14.

The e-commerce servers 120 and 140 provide an electronic commerce application to other machines (e.g., the devices 150) via the network 170. The e-commerce servers 120 and 140 may also be connected directly to, or integrated with, the recommendation server 130. In some example embodiments, one e-commerce server 120 and the recommendation server 130 are part of a network-based system 110, while other e-commerce servers (e.g., the e-commerce server 140) are separate from the network-based system 110. The electronic commerce application may provide a way for users to buy and sell items directly to each other, to buy from and sell to the electronic commerce application provider, or both.

Also shown in FIG. 1 is a user 160. The user 160 may be a human user (e.g., a human being), a machine user (e.g., a computer configured by a software program to interact with the devices 150 and the recommendation server 130), or any suitable combination thereof (e.g., a human assisted by a machine or a machine supervised by a human). The user 160 is not part of the network environment 100, but is associated with the devices 150 and may be a user of the devices 150. For example, the device 150 may be a sensor, a desktop computer, a vehicle computer, a tablet computer, a navigational device, a portable media device, or a smart phone belonging to the user 160.

In some example embodiments, the recommendation server 130 receives data regarding an item and an individual associated with a user. For example, a user may purchase an item from an e-commerce site hosted by the e-commerce server 120 and indicate that the item is intended as a gift for another person. Accordingly, the recommendation server 130 creates an association between the purchased item and the other person. Based on the association or a set of such associations, the recommendation server 130 identifies one or more item listings for recommendation as gifts for the other person. Additional factors for selecting recommended items include one or more of the following data about the recipient, in some example embodiments: region (e.g., state, country, or zip code), age, demographics, segmentation modeling, and third-party data from a social network, ad agency, or other e-commerce sites. By tracking the sets of associations for different people, personalized gift recommendations can be made. For example, recommendations may be provided for friends, family members, and co-workers of the user as well as the user him or herself. Other examples include suggestions of items to purchase for charities, schools, or the user's business.

Any of the machines, databases, or devices shown in FIG. 1 may be implemented in a general-purpose computer modified (e.g., configured or programmed) by software to be a special-purpose computer to perform the functions described herein for that machine, database, or device. For example, a computer system able to implement any one or more of the methodologies described herein is discussed below with respect to FIGS. 13-14. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 170 may be any network that enables communication between or among machines, databases, and devices (e.g., the recommendation server 130 and the devices 150). Accordingly, the network 170 may be a wired network, a wireless network (e.g., a mobile or cellular network), or any suitable combination thereof. The network 170 may include one or more portions that constitute a private network, a public network (e.g., the Internet), or any suitable combination thereof.

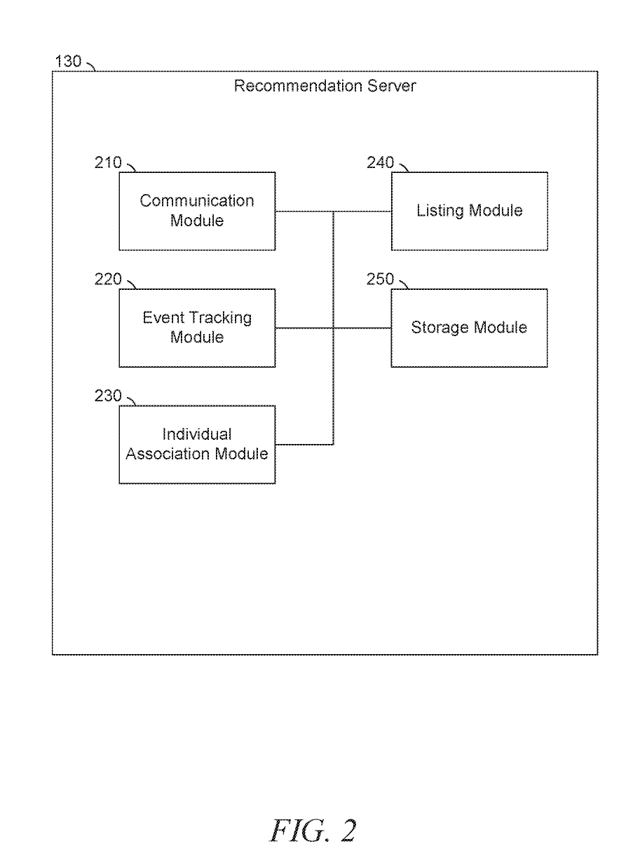

FIG. 2 is a block diagram illustrating components of the recommendation server 130, according to some example embodiments. The recommendation server 130 is shown as including a communication module 210, an event tracking module 220, an individual association module 230, a listing module 240, and a storage module 250 all configured to communicate with each other (e.g., via a bus, shared memory, or a switch). Any one or more of the modules described herein may be implemented using hardware (e.g., a processor of a machine). Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

The communication module 210 is configured to semi and receive data. For example, the communication module 210 may receive item listing data over the network 170 and send the received data to the individual association module 230. As another example, the listing module 240 may select item listings for an individual associated with a particular user, and the selected item listing may be transmitted by the communication module 210 over the network 170 to the e-commerce server 120 or 140.

In some example embodiments, the communication module 210 is implemented with network communication hardware, such as an Ethernet adapter or WiFi adapter. Through the use of a driver for the adapter, data is transmitted and received by applications on the recommendation server 130.

The event tracking module 220 is configured to track events or occasions for individuals. An event is any opportunity for a purchase associated with a particular date. In some example embodiments, the event is a gift-giving event. The event may be a one-time event or a recurring event. Example events include a birthday, an anniversary, a graduation, a holiday, a baby shower, and a wedding. Of these examples, birthdays, anniversaries, and holidays are recurring and graduations, baby showers, and weddings are one-time events. In some example embodiments, the event is an event for a business, charity, or other organization. For example, a retail business may need to buy products for resale for the Christmas season or to buy food, drinks, or employee gifts for a holiday party. As another example, a charity may have an annual auction and a donor to the charity may create a recurring event to purchase interesting items to donate to the auction.

In some example embodiments, the event tracking module 220 stores information about the events and the associations between the events and the individuals in a relational database. For example, an event table including rows of the form (date, event name, event id), an individual table including rows of the form (individual name, individual id), and an association table including rows of the form (giving individual id, receiving individual id, event id, association id) may be used. With this example structure, each event has an entry in the event table, each individual has an entry in the individual table, and each giving event has one entry in the association table for each unique combination of the giver, the recipient, and the event.

The individual association module 230 is configured to associate item listings with individuals and store the association in the storage module 250. In some example embodiments, the recommendation server 130 uses a database table in the storage module 250 to associate item listings for items purchased for individuals with the individual for which the item was purchased. For example, a purchases table including rows of the form (individual id, item id, date, purchase id) may be used. With this example structure, each purchase has an entry in the purchases table. An item table including rows of the form (item id, item name, start date, end date), an attribute table including rows of the form (attribute id, attribute name), and an item-attributes table including rows of the form (item id, attribute id) may be used to store additional information about each item listing. With this example structure, database queries efficiently access information about individual purchases and aggregated information about the individual's purchase history.

The listing module 240 is configured to select an item listing as a recommended item listing for an individual. For example, after a user has added three item listings to a watch list and indicated that each of the items in the item listings is intended as a gift for a particular individual, the listing module 240 selects a fourth item listing based on attributes of the three item listings and information regarding other users who also are associated with one or more of the three item listings, who have similar demographics to the particular individual, or other factors. The listing module 240 provides the selection to the user, via the communication module 210.

In some example embodiments, machine learning techniques are used to select the recommended item listing. For example, a training set of data includes a number of data pairs. The first part of the pair is the input object and the second part is the desired output value. Thus, the purchase history for an individual before a selected date may be used as the input data object and the purchase history after the selected date may be used as the desired output value. Aggregating many of these observed pairs for a number of individuals provides the training set. After training, the algorithm has a certain probability of correctly identifying items that an individual is likely to purchase.

The storage module 250 is configured to store and retrieve data generated and used by the event tracking module 220, the individual association module 230, and the listing module 240. For example, the algorithm used by the listing module 240 can be stored by the storage module 250. Information regarding associations between users and the individuals for whom they buy items can also be stored by the storage module 250. In some example embodiments, a many-to-many checklist of buyers for an individual recipient is stored by the storage module 250. For example, when multiple individuals are buying birthday gifts for a common friend, a notification may be generated to each remaining individual when an individual indicates that the birthday shopping is complete. To illustrate, if Alan, Brad, and Carl are buying birthday presents for Rich, and Alan completes a purchase, Brad and Carl can be notified that Alan is done and what Alan purchased. Then, if Brad is the next to make a purchase, Carl can be informed that Brad is done and what Brad purchased. In this way, the chance of purchasing redundant gifts is reduced and participation of all participants is encouraged.

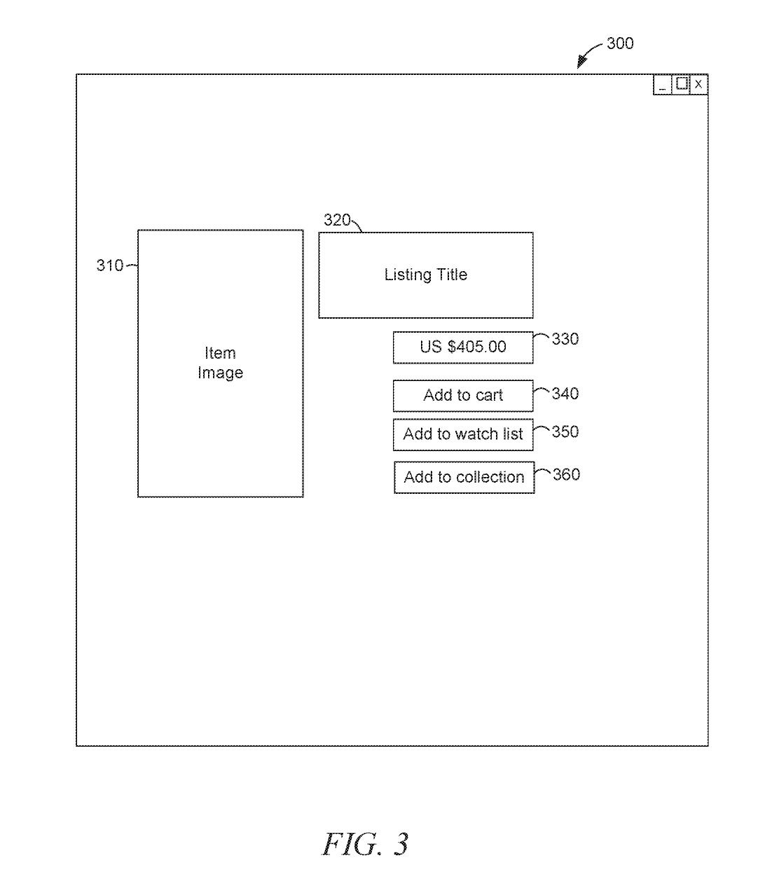

FIG. 3 is a block diagram 300 illustrating a user interface suitable for displaying an item listing, according to some example embodiments. As can be seen in block diagram 300, an item image 310, a listing title 320, a price 330, and buttons 340-360. The screen of FIG. 3 may be presented after a user selects an item listing to interact with from a listing view. For example, a user may enter a search query and have a number of listings presented. The user may select one of the listings to cause the screen of FIG. 3 to be presented, including more information or a larger image than in the listing view. The item image 310 is an image associated with the listing and may be a depiction of the listed item. The listing title 320 is a title of the listing and may include a short description of the listed item. The price 330 displays a price of the listed item, which may be a fixed price, an auction price, an offer price, or another price. The button 340 is operable to add the listed item to a shopping cart or to purchase the item. The button 350 is operable to add the listing to a watch list. When a predetermined event occurs on the watched listing, the user will receive a notification. The button 360 is operable to add the listing to a collection. The collection of selected item listings is made available for browsing to other users and for review by the creating user.

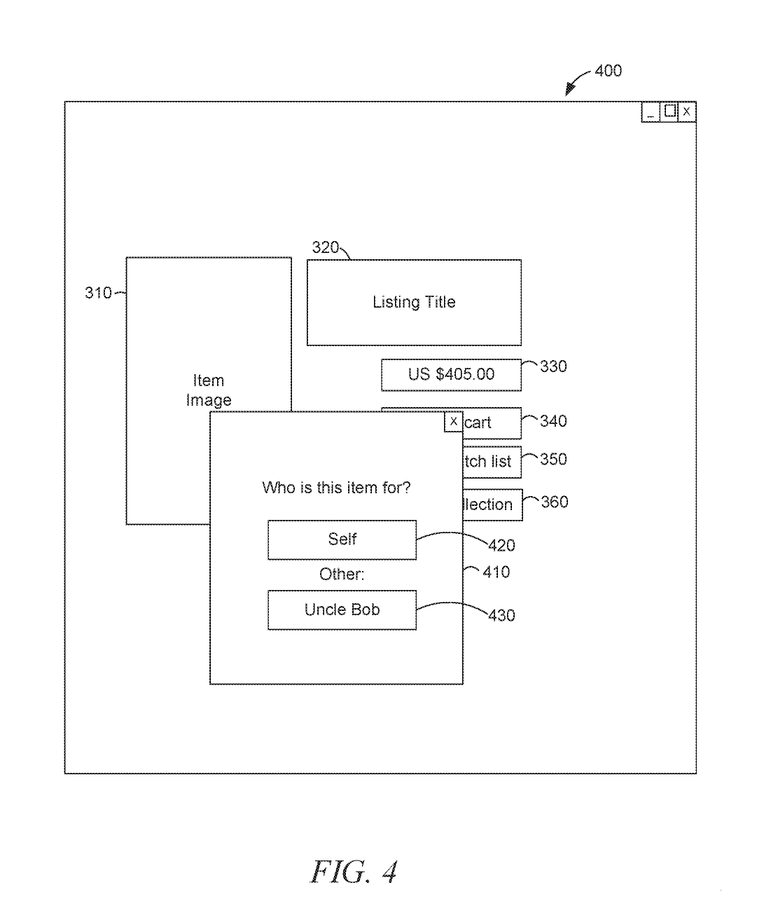

FIG. 4 is a block diagram 400 illustrating a user interface suitable for identifying an intended recipient of an item in an item listing, according to some example embodiments. The window 410 includes a button 420 and a text field 430. The button 420 is operable to indicate that the item is for the shopping user. The text field 430 accepts a text entry by the user to identify another individual for whom the item is being considered or purchased. For example, if the item is intended as a birthday present for Uncle Bob, the user may type “Uncle Bob” into the text field. Other modes of selection may also be used. For example, a set of radio buttons or check boxes may be presented, each corresponding to an individual already associated with the shopping user. The associations between individuals and the shopping user may be drawn from a social network, from previously-entered individual names in previous instances of the text field 430, or any suitable combination thereof. In some example embodiments, the window 410 is displayed while the user is viewing an item listing (e.g., the item listing of FIG. 3, including elements 310-360).

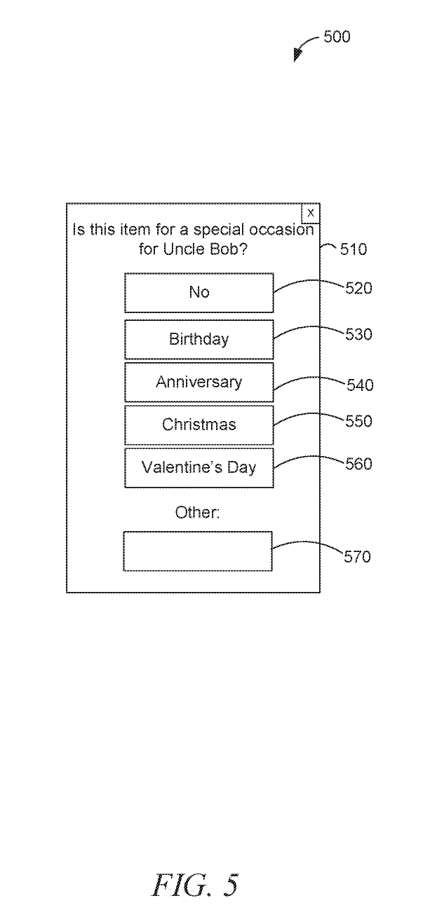

FIG. 5 is a block diagram 500 illustrating a user interface suitable for identifying an occasion associated with an item for an intended recipient, according to some example embodiments. The user interface of FIG. 5 may be displayed after a recipient other than the shopping user is identified as being the intended recipient of an item using the user interface of FIG. 4. The user interface of FIG. 5 includes a window 510, buttons 520-560, and text field 570. The button 520 is operable to indicate that the item is not for a particular occasion. The buttons 530-560 are operable to indicate that the item is for one of a predetermined set of occasions. In the example embodiment of FIG. 5, the predetermined set of occasions includes a birthday, an anniversary, Christmas, and Valentine's Day. The text field 570 accepts text typed by a user to define an occasion not in the predetermined set. For example, the user may type “Bon Voyage” to indicate that the gift is for a going-away party.

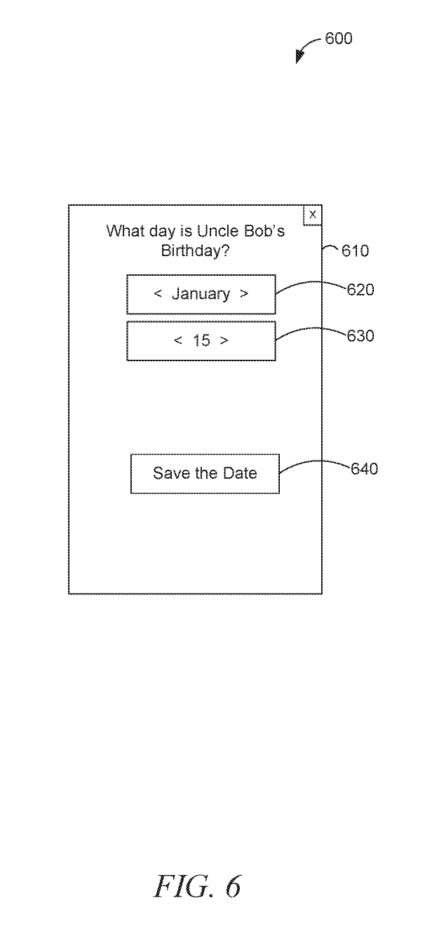

FIG. 6 is a block diagram 600 illustrating a user interface suitable for identifying a date associated with an occasion, according to some example embodiments. The user interface of FIG. 6 may be displayed after the shopping user has selected an occasion for giving an item using the user interface of FIG. 5. The user interface of FIG. 6 includes a window 610, a month selector 620, a day selector 630, and a button 640. The month selector 620 and day selector 630 are jointly operable to select a date for the occasion. The button 640 is operable to associate the selected date with the intended recipient.

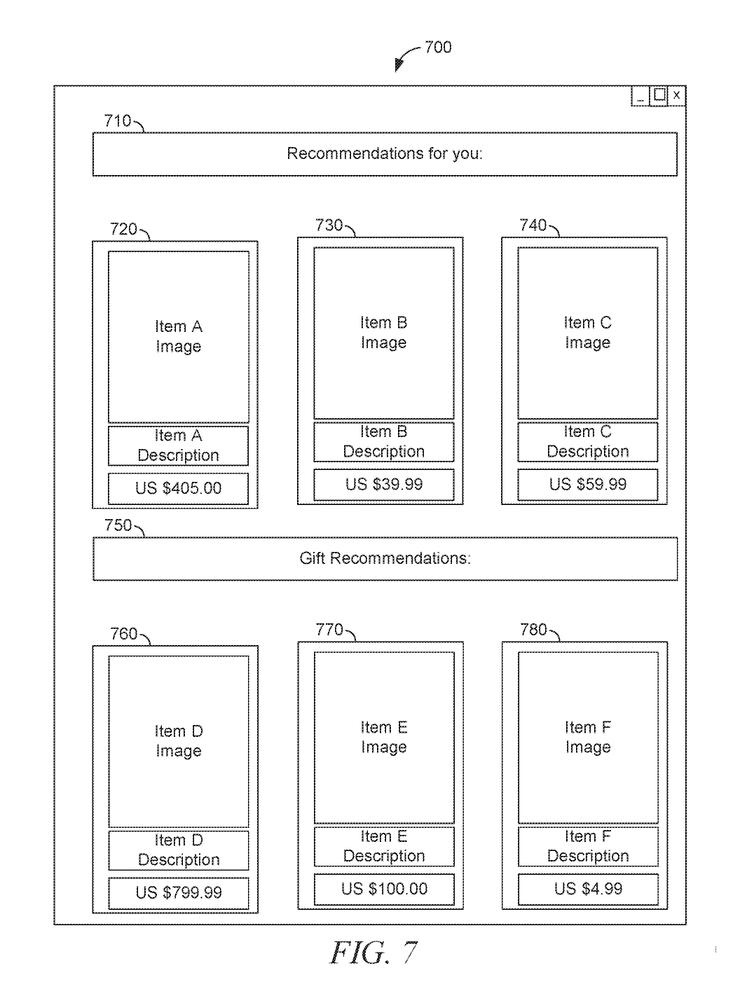

FIG. 7 is a block diagram 700 illustrating a user interface suitable for displaying sets of recommended item listings associated with different recipients, according to some example embodiments. FIG. 7 includes headers 710 and 750 and item listings 720, 730, 740, 760, 770, and 780. Each item listing includes an image, a description, and a price. The item listings 720, 730, and 740 are grouped under the header 710, which indicates that the item listings 720, 730, and 740 are recommended listings for the shopping user. For example, the item listings 720, 730, and 740 may have been selected based on the prior shopping activity of the user for him or herself.

The item listings 760, 770, and 780 are grouped under the header 750, which indicates that the item listings 760, 770, and 780 are recommended listings for gifts for others. For example, the item listings 760, 770, and 780 may have been selected based on the prior shopping activity of the user for others. Each item listing, or a portion thereof, may be operable to cause display of the window 410 of FIG. 4. For example, the user may recognize the item listing 720 as being for an item of interest as a gift for another instead of for purchase for the user him or herself. Accordingly, the user may click on a designated portion of the item listing 720, right-click on the item listing 720, or force-press (i.e., to press and then press harder) on the item listing 720 to cause the window 410 to appear. In some example embodiments, a press on the item listing 720 exceeding a predetermined duration is used to cause the window 410 to appear. Using the window 410, the user may select an intended recipient for the item depicted in the item listing 720. As a result, the item listing 720 is removed from the “recommendations for you” portion of the user interface and, optionally, added to the “gift recommendations” portion of the user interface. Additionally, the item of the item listing 720 may be added to a list of items of interest for the intended recipient and, if present, removed from a list of items of interest for the person for whom the recommendation was originally made (e.g., the shopping user).

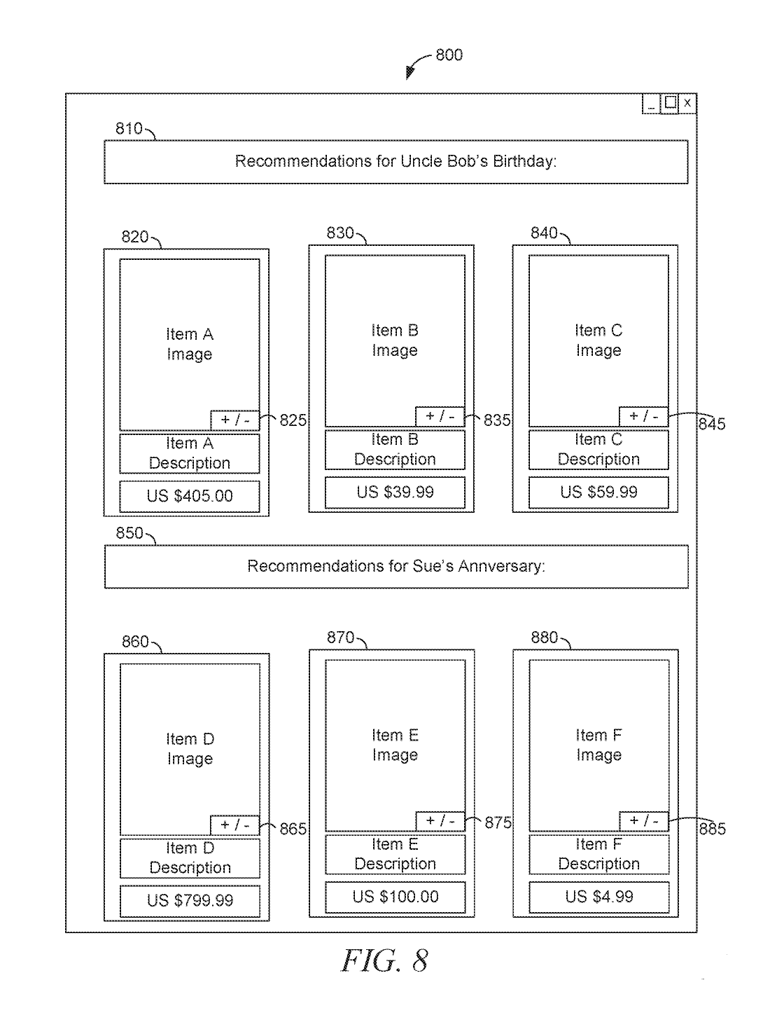

FIG. 8 is a block diagram 800 illustrating a user interface suitable for displaying sets of recommended item listings associated with different occasions, according to some example embodiments. FIG. 8 includes headers 810 and 850 and item listings 820, 830, 840, 860, 870, and 880. Each item listing includes an image, a description, a price, and an approve/disapprove control 825, 835, 845, 865, 875, 885. The item listings 820, 830, and 840 are grouped under the header 810, which indicates that the item listings 820, 830, and 840 are recommended listings for a particular recipient for a particular occasion, in this case, for Uncle Bob's birthday.

The item listings 860, 870, and 880 are grouped under the header 850, which indicates that the item listings 860, 870, and 880 are recommended listings for a different recipient/occasion pair, in this case, for Sue's anniversary. Each item listing, or a portion thereof, may be operable to cause display of the window 410 of FIG. 4. For example, the user may recognize the item listing 860 as being for an item of interest as a gift for Uncle Bob instead of for purchase for Sue. Accordingly, the user may click on a designated portion of the item listing 860, right-click on the item listing 860, or force-press on the item listing 860 to cause the window 410 to appear. Using the window 410, the user may select an intended recipient for the item depicted in the item listing 860 (e.g., “Sue”). As a result, the item listing 820 is removed from the “recommendations for Uncle Bob's Birthday” portion of the user interface and, optionally, added to the “recommendations for Sue's Anniversary” portion of the user interface.

The approve/disapprove controls 825, 835, 845, 865, 875, and 885 are operable to indicate whether or not the shopping user agrees with the corresponding recommendation. As shown in FIG. 8, the approve control is marked with a “+” and the disapprove control is marked with a “−”. Other visual indicators may be used, such as thumbs up/thumbs down, green light/red light, or any suitable combination thereof. In some example embodiments, in response to receiving an indication that the user approves of the recommendation, the recommended item is added to the list of items of interest for the recipient (e.g., Uncle Bob for item listing 820 or Sue for item listing 860). In some example embodiments, in response to receiving an indication that the user disapproves of the recommendation, the recommended item is added to a do-not-recommend list for the recipient. When future recommendations are made, any recommendations that are present on the do-not-recommend list are prevented from being presented to the user.

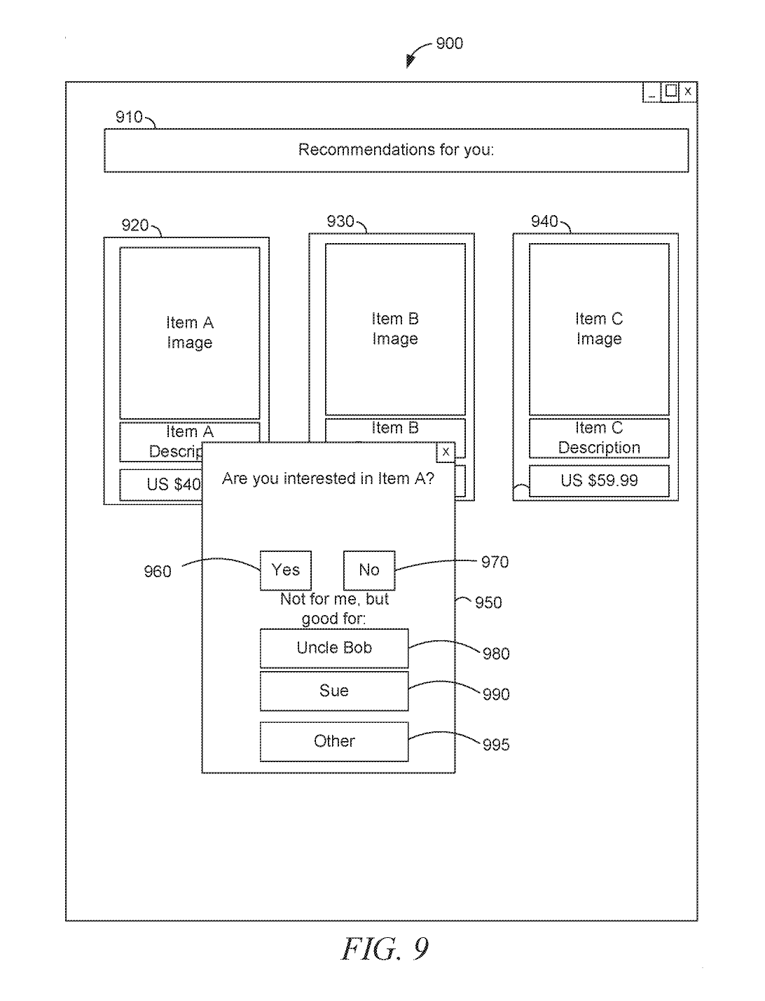

FIG. 9 is a block diagram illustrating a user interface suitable for identifying an intended recipient of an item in an item listing, according to some example embodiments. The user interface of FIG. 9 includes a heading 910, listings 920-940, a window 950, and buttons 960-995. The window 950 may be presented in response to a user command directed toward one of the listings 920-940. For example, the user may tap on a touch screen, click with a mouse, provide a voice command, or use keyboard controls to select and interact with one of the listings 920-940. In some example embodiments, left-clicking on one of the listings 920-940 causes display of the user interface of FIG. 3, showing additional information or options for the listing, while right-clicking on the same listing causes display of the window 950. The buttons 960-995 are operable to identify the intended recipient of the item. For example, the button 960 is operable to identify the shopping user as the intended recipient, the button 970 is operable to disassociate the item from the shopping user without creating another association, the button 980 is operable to associate the item with the recipient “Uncle Bob,” the button 990 is operable to associate the item with the recipient “Sue,” and the button 995 is operable to cause presentation of a prompt with which the user can identify a new recipient. In the example window 950, the labels of buttons 980 and 990 are selected from previous recipients identified by the user. In other example embodiments, common choices are presented even if the user has not previously selected that recipient. For example, “Mom,” “Dad,” “Husband,” “Wife,” “Son,” and “Daughter” may be presented as options.

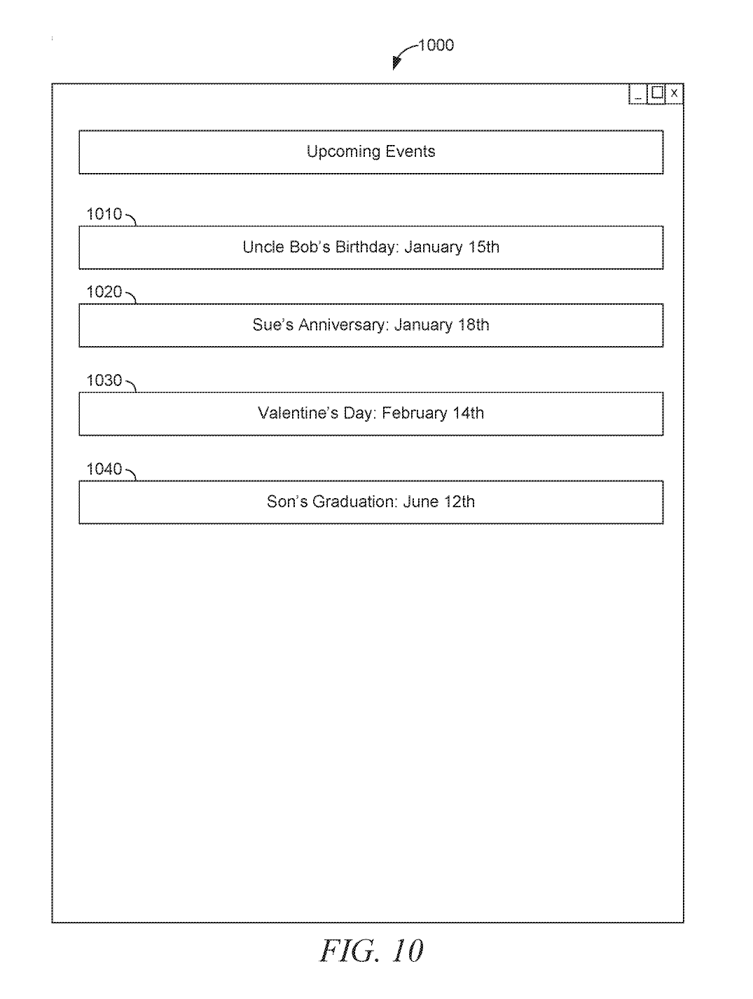

FIG. 10 is a block diagram 1000 illustrating a user interface suitable for presenting upcoming gift-giving events, according to some example embodiments. Elements 1010-1040 each show a gift-giving event and a corresponding date. Elements 1010, 1020, and 1040 indicate an intended recipient associated with the corresponding event. In some example embodiments, a calendar view is shown, with the information of elements 1010-1040 included directly on the calendar (e.g., in a box corresponding to the date of the event) or through a link. For example, January 15^{th} may be highlighted on the calendar and operable to cause the display of the information “Uncle Bob's Birthday.” By interacting with the element 1010, the user can cause the system to present gift suggestions for the corresponding event and intended recipient (e.g., elements 810-845 of FIG. 8). The recommendation server 130 and the e-commerce servers 120 or 140 present similar interfaces after interaction with elements 1020-1040.

The events depicted in FIG. 10 are selected by the recommendation server 130 based on current and prior events entered by the user, events made public by intended recipients associated with the user, global events defined by the recommendation server 130, and the current date. For example, using the user interface of FIGS. 4-6, the user identifies Uncle Bob's birthday as a gift-giving event, and provides the date of the birthday. Accordingly, Uncle Bob's birthday may be presented in the user interface of FIG. 10 until the user indicates that an item has been purchased for the event or until the date for the event has passed. In some example embodiments, the reminder for the event remains until dismissed by the user even after the date has passed. As the anniversary of the birthday approaches (e.g., is within 30 days), the event reappears.

As another example, a relationship exists between the user and another user. For example, the user may be friends with Sue on a social network that shares information with the e-commerce server 120 or 140 or the recommendation server 130. Sue chooses to share her wedding anniversary date with her friends. Accordingly, the recommendation server 130 creates an event for the user for Sue's anniversary. As with the example for Uncle Bob, an event for Sue's anniversary is presented for the user in FIG. 10 until a gift is purchased, the date passes, or the user dismisses the event.

As yet another example, the event may be a global event defined by the recommendation server 130, such as Valentine's Day. The presentation of element 1030, showing that Valentine's Day is on February 14^{th}, is not, in this example, based on any prior action of the user or an associated user, but merely on the current date and the upcoming holiday.

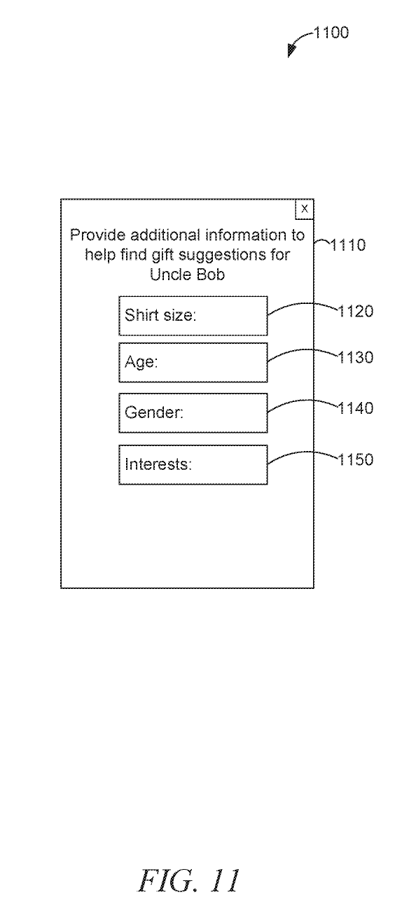

FIG. 11 is a block diagram 1100 illustrating a user interface suitable for gathering additional information regarding an item recipient, according to some example embodiments. As shown in FIG. 11, the user interface includes a window 1110 and fields 1120-1150. Each field 1120-1150 is operable to enter information regarding the identified recipient. The window 1110 may be presented in response to a selection by the user of an option to add additional information regarding an intended recipient or presented automatically by the recommendation server 130 (e.g., after presentation of the user interface of FIG. 6). The information gathered may be used in generating recommendations for the intended recipient.

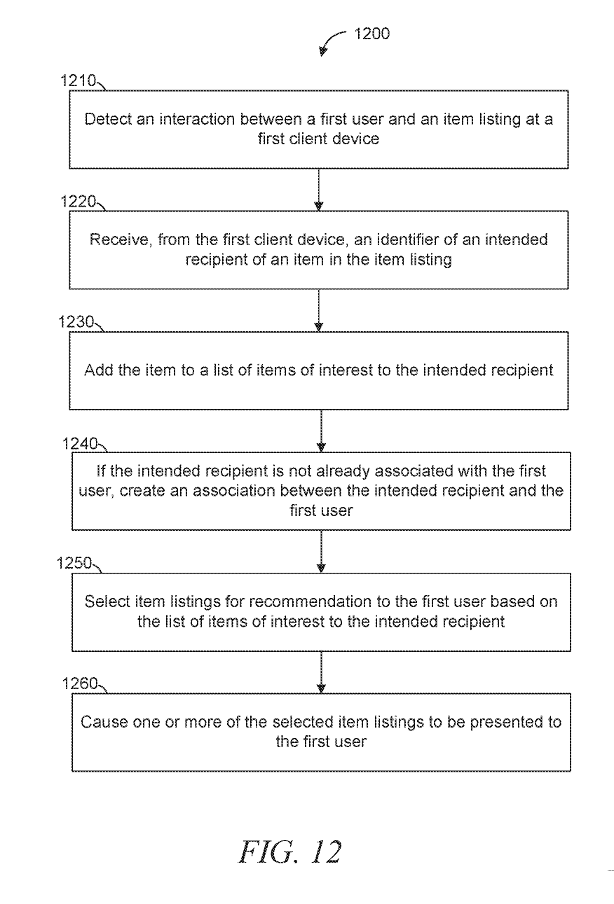

FIG. 12 is a flowchart illustrating operations of one or more servers in performing a process 1200 of generating recommendations, according to some example embodiments. The process 1200 includes operations 1210-1260. By way of example and not limitation, the operations of the process 1200 are described as being performed by the systems of FIG. 1 and the modules of FIG. 2.

In operation 1210, the recommendation server 130 detects an interaction between a first user and an item listing at a first client device. In some example embodiments, the interaction between the user and the item listing occurs in a web browser or mobile application running on a client device (e.g., the client device 150A), which transmits information to the e-commerce server 120 or 140, which notifies the recommendation server 130.

In various example embodiments, different interactions are detected by the recommendation server 130. In some example embodiments, any interaction at all with the item listing (e.g., viewing the listing, watching the item, bidding on the item, purchasing the item, or making an offer on the item) is counted as an interaction for the purposes of the process 1200. In other example embodiments, only certain predetermined activities are counted as interactions. The mere presentation of an item listing does not constitute an interaction, which always requires some form of action by the user. For example, viewing the listing may be accomplished by tapping on or clicking on the search result, causing the presentation of additional details not shown in the search result. As another example, watching the item may be accomplished by tapping on or clicking on a hot spot in the search result, or may require first viewing the listing and then interacting with a user interface element shown along with the additional details. Watching an item causes the watching user to be notified when events occur with the item listing. For example, a notification may be sent to a watching user when the listing is closing soon (e.g., within 24 hours, within 4 hours, or within another time frame) or when another user outbids the watching user.

In operation 1220, the recommendation server 130 receives, from the first client device, an identifier of an intended recipient of an item in the item listing. In some example embodiments, the identifier is transferred from the client device to the e-commerce server 120 or 140 and then from the e-commerce server 120 or 140 to the recommendation server 130. The identifier may be transformed during this process. For example, the user may enter a character string containing the name of the intended recipient into a web browser or mobile application. In response, the browser transmits the character string over the network 170 to the e-commerce machine 120 or 140. The e-commerce machine 120 or 140 attempts to look up the recipient's name in a database. If the look up succeeds, a unique identifier for the recipient is transmitted to the recommendation server 130 (e.g., a unique numeric identifier). If the look up fails, a unique identifier for the recipient is generated, the correspondence between the generated identifier and the name is stored in the database, and the generated identifier is transmitted to the recommendation server 130.

The recommendation server 130, in operation 1230, adds the item to a list of items of interest to the intended recipient. In some example embodiments, the item is removed from a list of items of interest to the user, if already present on that list. Accordingly, a relationship between the item and the intended recipient is created that allows suggestions to be made for the intended recipient based on the item being of interest for the intended recipient. Meanwhile, no corresponding relationship between the item and the giving user is created, allowing suggestions to be made for the giving user's own consumption that are based on the item not being of interest to the shopping user.

In some example embodiments the list of items of interest is stored in a table in a relational database. For example, an interests table having rows of the form (individual id, item id) may be used. Using this example table, an entry is created for each individual/item pair. Accordingly, each individual may be associated with multiple items, and each item may be associated with multiple individuals.

Other items in the list of items of interest to the intended recipient may include items selected in previous iterations of the process 1200 and items selected by the intended recipient (e.g., in a wish list). For example, the user may have indicated several items that are possible gifts for Uncle Bob. Additionally, Uncle Bob may have placed several items on a wish list. Accordingly, the two lists may be merged into a single list of items of interest to Uncle Bob. Alternatively, the two lists may be maintained separately. Items on a wish list may be removed once purchased. For example, when multiple people are shopping for a single recipient, once one of them purchases an item on the wish list, that item can be removed from the wish list, preventing the removed item from being presented to other gift-givers and reducing the chance that the same gift will be purchased twice. In some example embodiments, the removed item is checked off on the wish list, allowing other shoppers to also avoid purchasing the item through other avenues.

In operation 1240, the recommendation server 130 determines whether the intended recipient is already associated with the first user. For example, if this is the first time that the first user has indicated that an item is for the intended recipient and the first user is not otherwise associated with the intended recipient, the recommendation server 130 determines that the intended recipient was not already associated with the first user. If the intended recipient is not already associated with the first user, the recommendation server 130 creates an association between the intended recipient and the first user. The association may be used later, for example in providing a user interface containing a pre-populated list of possible intended recipients. As discussed above with respect to FIG. 2, an association table having rows of the form (giving individual id, receiving individual id, event id, association id) may be used. Using this table, in conjunction with the individuals table, a query can easily determine if any associations between the giving individual and the receiving individual already exist. Similarly, querying these two tables can give a list of the names of all individuals to whom the giver has previously given items.

The listing module 240 selects, in operation 1250, item listings for recommendation to the first user based on the list of items of interest to the intended recipient. In some example embodiments, each item in the list of items of interest has a set of attributes and the recommended item listings are selected based on the attributes of the items of interest and attributes of the item listings. For example, if one or more of the items has a brand attribute of Nike®, item listings for items also having a brand attribute of Nike® may be selected. In embodiments in which a wish list is maintained separately from the list of items of interest, items on both lists may be used in selecting item listings for recommendation. Items of interest may also be added directly as recommendations. For example, one or more items on the intended recipient's wish list may be presented as recommendations for purchase for the intended recipient. Listings for the items on the wish list may be marked as such (e.g., by inclusion of a green check mark and the text “Wish List!”).

Other methods of selecting items for recommendation based on the known items of interest include: term frequency-inverse document frequency (tf-idf) ranking (i.e., identifying listings that have high frequencies of words having high frequency in the known item listings of interest), demographic recommendations (i.e., identifying listings that are popular among people in the same demographic group as the intended recipient), and event recommendations (i.e., identifying listings that are popular in conjunction with an event for which the item is being purchased).

In operation 1260, the recommendation server 130 or the e-commerce server 120 or 140 causes presentation to the first user of one or more of the selected item listings. For example, the communication module 210 of the recommendation server 130 may transmit data for the selected item listings to the e-commerce server 120. In this example, an HTTP server running on the e-commerce server 120 serves a web page to the user device 150A, including data for the selected item listings. Continuing the example, the user interface of FIG. 7 or FIG. 8 may be rendered by a web browser running on the user device 150A, in response to receiving the web page from the e-commerce server 120.

FIG. 13 is a flowchart illustrating operations of one or more servers in performing a process 1300 of generating recommendations, according to some example embodiments. The process 1300 includes operations 1310-1360. By way of example and not limitation, the operations of the process 1300 are described as being performed by the systems of FIG. 1 and the modules of FIG. 2. Operations 1310-1330 correspond to operations 1210-1230 described above with respect to FIG. 12.

In operation 1340, a date of an occasion associated with the intended recipient of the item is received by the event tracking module 220. For example, a date may have been selected by a user of the user interface shown in FIG. 6. Example occasions having associated dates include birthdays, wedding anniversaries, employment anniversaries, and holidays.

The listing module 240 selects, in operation 1350, item listings for recommendation to the first user based on the list of items of interest to the intended recipient. In operation 1360, the recommendation server 130 or the e-commerce server 120 or 140 causes presentation, to the first user and based on the date of the occasion, one or more of the selected item listings. For example, if a birthday gift is purchased for Uncle Bob for his birthday on Feb. 1, 2016, a recommended birthday gift for Uncle Bob may be presented on Jan. 1, 2017, based on the proximity of that date with Uncle Bob's next birthday.

When these effects are considered in aggregate, one or more of the methodologies described herein may obviate a need for certain efforts or resources that otherwise would be involved in selecting item listings for recommendation. Efforts expended by a user in finding items of interest to another recipient may also be reduced by one or more of the methodologies described herein. For example, accurately identifying an item of interest for a potential recipient may reduce the amount of time or effort expended by the user in finding an item to purchase as a gift. Computing resources used by one or more machines, databases, or devices (e.g., within the network environment 100) may similarly be reduced. Examples of such computing resources include processor cycles, network traffic, memory usage, data storage capacity, power consumption, and cooling capacity.

### Software Architecture

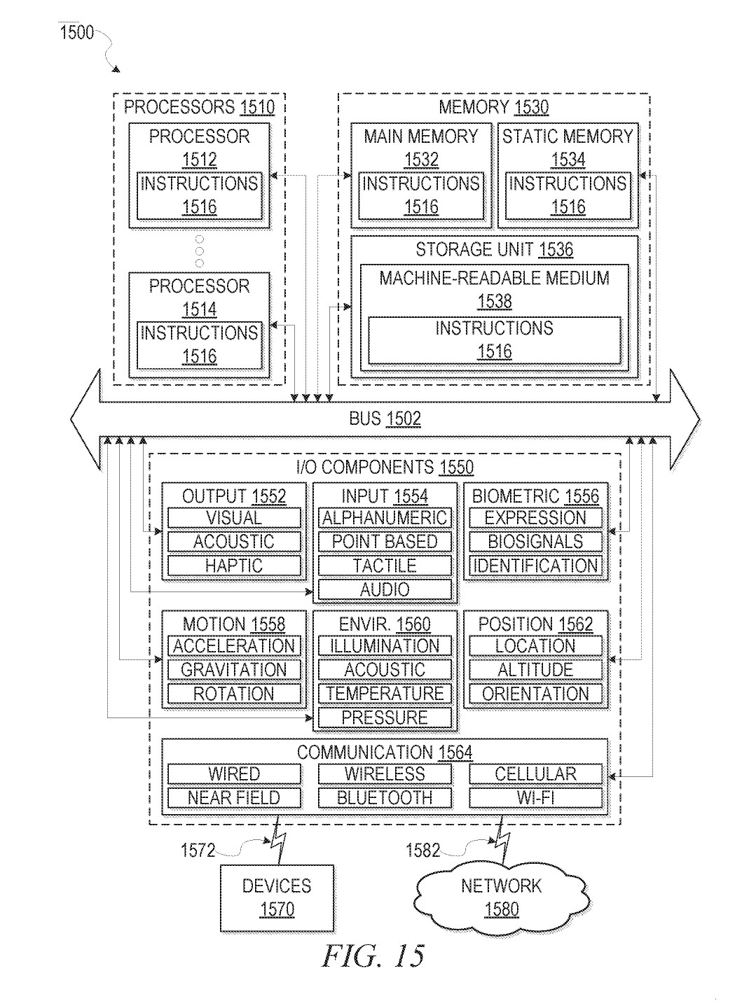

FIG. 14 is a block diagram 1400 illustrating a software architecture 1402, which may be installed on any one or more of the devices described above. FIG. 14 is merely a non-limiting example of a software architecture, and it will be appreciated that many other architectures may be implemented to facilitate the functionality described herein. The software architecture 1402 may be implemented by hardware such as machine 1500 of FIG. 15 that includes processors 1510, memory 1530, and input/output (I/O) components 1550. In this example architecture, the software architecture 1402 may be conceptualized as a stack of layers where each layer may provide a particular functionality. For example, the software architecture 1402 includes layers such as an operating system 1404, libraries 1406, frameworks 1408, and applications 1410. Operationally, the applications 1410 invoke application programming interface (API) calls 1412 through the software stack and receive messages 1414 in response to the API calls 1412, according to some implementations.

In various implementations, the operating system 1404 manages hardware resources and provides common services. The operating system 1404 includes, for example, a kernel 1420, services 1422, and drivers 1424. The kernel 1420 acts as an abstraction layer between the hardware and the other software layers in some implementations. For example, the kernel 1420 provides memory management, processor management (e.g., scheduling), component management, networking, security settings, among other functionality. The services 1422 may provide other common services for the other software layers. The drivers 1424 may be responsible for controlling or interfacing with the underlying hardware. For instance, the drivers 1424 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth.

In some implementations, the libraries 1406 provide a low-level common infrastructure that may be utilized by the applications 1410. The libraries 1406 may include system libraries 1430 (e.g., C standard library) that may provide functions such as memory allocation functions, string manipulation functions, mathematic functions, and the like. In addition, the libraries 1406 may include API libraries 1432 such as media libraries (e.g., libraries to support presentation and manipulation of various media formats such as Moving Picture Experts Group-4 (MPEG4). Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1406 may also include a wide variety of other libraries 1434 to provide many other APIs to the applications 1410.

The frameworks 1408 provide a high-level common infrastructure that may be utilized by the applications 1410, according to some implementations. For example, the frameworks 1408 provide various graphic user interface (GUI) functions, high-level resource management, high-level location services, and so forth. The frameworks 1408 may provide a broad spectrum of other APIs that may be utilized by the applications 1410, some of which may be specific to a particular operating system or platform.

In an example embodiment, the applications 1410 include a home application 1450, a contacts application 1452, a browser application 1454, a book reader application 1456, a location application 1458, a media application 1460, a messaging application 1462, a game application 1464, and a broad assortment of other applications such as third party application 1466. According to some embodiments, the applications 1410 are programs that execute functions defined in the programs. Various programming languages may be employed to create one or more of the applications 1410, structured in a variety of manners, such as object-orientated programming languages (e.g., Objective-C, Java, or C++) or procedural programming languages (e.g., C or assembly language). In a specific example, the third party application 1466 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third party application 1466 may invoke the API calls 1412 provided by the mobile operating system 1404 to facilitate functionality described herein.

### Example Machine Architecture and Machine-Readable Medium

FIG. 15 is a block diagram illustrating components of a machine 1500, according to some example embodiments, able to read instructions from a machine-readable medium (e.g., a machine-readable storage medium) and perform any one or more of the methodologies discussed herein. Specifically, FIG. 15 shows a diagrammatic representation of the machine 1500 in the example form of a computer system, within which instructions 1516 (e.g., software, a program, an application, an applet, an app, or other executable code) for causing the machine 1500 to perform any one or more of the methodologies discussed herein may be executed. In alternative embodiments, the machine 1500 operates as a standalone device or may be coupled (e.g., networked) to other machines. In a networked deployment, the machine 1500 may operate in the capacity of a server machine or a client machine in a server-client network environment, or as a peer machine in a peer-to-peer (or distributed) network environment. The machine 1500 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1516, sequentially or otherwise, that specify actions to be taken by machine 1500. Further, while only a single machine 1500 is illustrated, the term “machine” shall also be taken to include a collection of machines 1500 that individually or jointly execute the instructions 1516 to perform any one or more of the methodologies discussed herein. As a practical matter, certain embodiments of the machine 1500 may be more suitable to the methodologies described herein. For example, while any computing device with sufficient processing power may serve as the recommendation server 130, accelerometers, cameras, and cellular network connectivity are not directly related to the ability of the recommendation server 130 to perform the recommendation methods discussed herein. Accordingly, in some example embodiments, cost savings are realized by implementing the various described methodologies on machines 1500 that exclude additional features unnecessary to the performance of the tasks assigned to each machine 1500 (e.g., by implementing the recommendation server 130 in a server machine without a directly connected display and without integrated sensors commonly found only on wearable or portable devices).

The machine 1500 may include processors 1510, memory 1530, and I/O components 1550, which may be configured to communicate with each other via a bus 1502. In an example embodiment, the processors 1510 (e.g., a Central Processing Unit (CPU), a Reduced Instruction Set Computing (RISC) processor, a Complex instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 1512 and processor 1514 that may execute instructions 1516. The term “processor” is intended to include multi-core processors that may comprise two or more independent processors (also referred to as “cores”) that may execute instructions contemporaneously. Although FIG. 15 shows multiple processors, the machine 1500 may include a single processor with a single core, a single processor with multiple cores (e.g., a multi-core process), multiple processors with a single core, multiple processors with multiples cores, or any combination thereof.

The memory 1530 may include a main memory 1532, a static memory 1534, and a storage unit 1536 accessible to the processors 1510 via the bus 1502. The storage unit 1536 may include a machine-readable medium 1538 on which is stored the instructions 1516 embodying any one or more of the methodologies or functions described herein. The instructions 1516 may also reside, completely or at least partially, within the main memory 1532, within the static memory 1534, within at least one of the processors 1510 (e.g., within the processor's cache memory), or any suitable combination thereof, during execution thereof by the machine 1500. Accordingly, in various implementations, the main memory 1532, static memory 1534, and the processors 1510 are considered as machine-readable media 1538.

As used herein, the term “memory” refers to a machine-readable medium 1538 able to store data temporarily or permanently and may be taken to include, but not be limited to, random-access memory (RAM), read-only memory (ROM), buffer memory, flash memory, and cache memory. While the machine-readable medium 1538 is shown in an example embodiment to be a single medium, the term “machine-readable medium” should be taken to include a single medium or multiple media (e.g., a centralized or distributed database, or associated caches and servers) able to store instructions 1516. The term “machine-readable medium” shall also be taken to include any medium, or combination of multiple media, that is capable of storing instructions (e.g., instructions 1516) for execution by a machine (e.g., machine 1500), such that the instructions, when executed by one or more processors of the machine 1500 (e.g., processors 1510), cause the machine 1500 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory (e.g., flash memory), an optical medium, a magnetic medium, other non-volatile memory (e.g., Erasable Programmable Read-Only Memory (EPROM)), or any suitable combination thereof. The term “machine-readable medium” specifically excludes non-statutory signals per se.

The I/O components 1550 include a wide variety of components to receive input, provide output, produce output, transmit information, exchange information, capture measurements, and so on. In general, it will be appreciated that the I/O components 1550 may include many other components that are not shown in FIG. 15. The I/O components 1550 are grouped according to functionality merely for simplifying the following discussion and the grouping is in no way limiting. In various example embodiments, the I/O components 1550 include output components 1552 and input components 1554. The output components 1552 include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor), other signal generators, and so forth. The input components 1554 include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instrument), tactile input components (e.g., a physical button, a touch screen that provides location and force of touches or touch gestures, or other tactile input components), audio input components (e.g., a microphone), and the like.

In some further example embodiments, the I/O components 1550 include biometric components 1556, motion components 1558, environmental components 1560, or position components 1562, among a wide array of other components. For example, the biometric components 1556 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1558 include acceleration sensor components (e,g., accelerometer), gravitation sensor components, rotation sensor components (e.g., gyroscope), and so forth. The environmental components 1560 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., machine olfaction detection sensors, gas detection sensors to detect concentrations of hazardous gases for safety or to measure pollutants in the atmosphere other components that may provide indications, measurements, or signals corresponding to a surrounding physical environment. The position components 1562 include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1550 may include communication components 1564 operable to couple the machine 1500 to a network 1580 or devices 1570 via coupling 1582 and coupling 1572, respectively. For example, the communication components 1564 include a network interface component or another suitable device to interface with the network 1580. In further examples, communication components 1564 include wired communication components, wireless communication components, cellular communication components, Near Field Communication (NFC) components, Bluetooth® components Bluetooth® Low Energy), Wi-Fi® components, and other communication components to provide communication via other modalities. The devices 1570 may be another machine or any of a wide variety of peripheral devices (e.g., a peripheral device coupled via a USB).

Moreover, in some implementations, the communication components 1564 detect identifiers or include components operable to detect identifiers. For example, the communication components 1564 include Radio Frequency Identification (RFID) tag reader components, NFC smart tag detection components, optical reader components (e.g., an optical sensor to detect a one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, Uniform Commercial Code Reduced Space Symbology (UCC RSS)-2D bar code, and other optical codes), acoustic detection components (e.g., microphones to identify tagged audio signals), or any suitable combination thereof. In addition, a variety of information can be derived via the communication components 1564, such as location via Internet Protocol (IP) geo-location, location via Wi-Fi® signal triangulation., location via detecting a NFC beacon signal that may indicate a particular location, and so forth.

### Transmission Medium

In various example embodiments, one or more portions of the network 1580 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 1580 or a portion of the network 1580 may include a wireless or cellular network and the coupling 1582 may be a Code Division Multiple Access (CDMA) connection, a Global System for Mobile communications (GSM) connection, or other type of cellular or wireless coupling. In this example, the coupling 1582 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UNITS), High Speed Packet Access (HSPA), Worldwide Interoperability for Microwave Access (WiMAX), Long Term Evolution (LTE) standard, others defined by various standard setting organizations, other long range protocols, or other data transfer technology.

In example embodiments, the instructions 1516 are transmitted or received over the network 1580 using a transmission medium via a network interface device (e.g., a network interface component included in the communication components 1564) and utilizing any one of a number of well-known transfer protocols (e.g., Hypertext Transfer Protocol (HTTP)). Similarly, in other example embodiments, the instructions 1516 are transmitted or received using a transmission medium via the coupling 1572 (e.g., a peer-to-peer coupling) to devices 1570. The term “transmission medium” shall be taken to include any intangible medium that is capable of storing, encoding, or carrying instructions 1516 for execution by the machine 1500, and includes digital or analog communications signals or other intangible medium to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A system comprising:
a memory having instructions embodied thereon; and
one or more processors configured by the instructions to perform operations comprising:
detecting an interaction with a first listing for an item by a user at a client device;
causing a user interface to be displayed on the client device, the user interface including a prompt to identify an intended recipient of the item, the intended recipient being different from the user;
receiving, via the user interface, an identifier of the intended recipient of the item;
selecting a first recommended listing based on a first set of listings interacted with by the user, the first set of listings excluding the first listing;
selecting a second recommended listing based on a second set of listings interacted with by the user, the second set of listings including the first listing;
causing the first recommended listing to be presented to the user; and
causing the second recommended listing to be presented to the user.

2. The system of claim 1, wherein:
the user interface further includes a prompt to identify an occasion for which the item is intended as a gift for the recipient;
the operations further comprise:
receiving, via the user interface, an identifier of the occasion;
determining a date of the occasion; and
the causing of the second recommended listing to be presented to the user is based on the date of the occasion and a current date.

3. The system of claim 2, wherein:
the causing of the second recommended listing to be presented to the user is based on a difference between the date of the occasion and the current date being below a threshold.

4. The system of claim 1, wherein:
the interaction with the first item listing is selected from the group comprising viewing the first item listing, bidding on the item, making an offer on the item, and watching the first item listing.

5. The system of claim 1, wherein:
the operations further comprise:
accessing a wish list for the recipient; and
the generating of the second recommended listing is based on the wish list.

6. The system of claim 1, wherein:
the generating of the second recommended listing is based on an attribute of the item that is indicated in the first item listing.

7. The system of claim 1, wherein:
the first recommended listing is presented in a first display region containing a first plurality of recommended listings;
the second recommended listing is presented in a second display region containing a second plurality of recommend listings; and
the operations further comprise:
causing a second user interface to be displayed on the client device, the second user interface including a prompt to identify a person that would be interested in an item of the first recommended listing;
receiving, via the second user interface, an indication that the recipient would be interested in the item of the first recommended listing; and
responsive to the receipt of the indication that the recipient would be interested in the item of the first recommended listing:
moving the first recommended listing from the first display region to the second display region.

8. The system of claim 1, wherein the operations further comprise:
causing, based on an association between a second user and the recipient, a presentation of the second recommended listing to the second user;
receiving, from the second user, a purchase order for an item of the second recommended listing; and
based on the receipt of the purchase order and the association between the second user and the recipient, ceasing to present the second recommended listing to the first user.

9. The system of claim 1, wherein the operations further comprise:
causing a second user interface to be displayed on the client device, the second user interface including a prompt to indicate whether or not the recipient would be interested in an item of the second recommended listing.

10. The system of claim 9, wherein the operations further comprise:
receiving, via the second user interface, an indication that the recipient would not be interested in the item of the second recommended listing; and
responsive to the receipt of the indication that the recipient would not be interested in the item of the second recommended listing:
ceasing display of the second recommend listing.

11. The system of claim 9, wherein the operations further comprise:
receiving, via the second user interface, an indication that the recipient would be interested in the item of the second recommended listing; and
responsive to the receipt of the indication that the recipient would be interested in the item of the second recommended listing:
selecting a third recommended listing based on the second set of listings interacted with by the user and the second recommended listing; and
causing the third recommended listing to be presented to the user.

12. The system of claim 1, wherein:
the first listing is from a first e-commerce site; and
the second recommended listing is from a second e-commerce site different from the first e-commerce site.

13. A method comprising:
detecting an interaction with a first listing for an item by a user at a client device;
causing a user interface to be displayed on the client device, the user interface including a prompt to identify an intended recipient of the item, the intended recipient being different from the user;
receiving, via the user interface, an identifier of the intended recipient of the item;
selecting a first recommended listing based on a first set of listings interacted with by the user, the first set of listings excluding the first listing;
selecting, by a processor of a machine, a second recommended listing based on a second set of listings interacted with by the user, the second set of listings including the first listing;
causing the first recommended listing to be presented to the user; and
causing the second recommended listing to be presented to the user.

14. The method of claim 13, wherein:
the user interface further includes a prompt to identify an occasion for which the item is intended as a gift for the recipient;
the method further comprises:
receiving, via the user interface, an identifier of the occasion;
determining a date of the occasion; and
the causing of the second recommended listing to be presented to the user is based on the date of the occasion and a current date.

15. The method of claim 14, wherein:
the causing of the second recommended listing to be presented to the user is based on a difference between the date of the occasion and the current date being below a threshold.

16. The method of claim 13, wherein:
the interaction with the first item listing is selected from the group comprising viewing the first item listing, bidding on the item, making an offer on the item, and watching the first item listing.

17. The method of claim 13, further comprising:
accessing a wish list for the recipient; and
wherein the generating of the second recommended listing is based on the wish list.

18. The method of claim 13, wherein:
the generating of the second recommended listing based on an attribute of the item that is indicated in the first item listing.

19. The method of claim 13, wherein:
the first recommended listing is presented in a first display region containing a first plurality of recommended listings;
the second recommended listing is presented in a second display region containing a second plurality of recommend listings; and
the method further comprises:
causing a second user interface to be displayed on the client device, the second user interface including a prompt to identify a person that would be interested in an item of the first recommended listing;
receiving, via the second user interface, an indication that recipient would be interested in the item of the first recommended listing; and
responsive to the receipt of the indication that the recipient would be interested in the item of the first recommended listing:
moving the first recommended listing from the first region to the second region.

20. A machine-readable medium having instructions embodied thereon, the instructions executable by one or more processors of a machine to perform operations comprising:
detecting an interaction with a first listing for an item by a user at a client device;
causing a user interface to be displayed on the client device, the user interface including a prompt to identify an intended recipient of the item, the intended recipient being different from the user;
receiving, via the user interface, an identifier of the intended recipient of the item;
selecting a first recommended listing based on a first set of listings interacted with by the user, the first set of listings excluding the first listing;
selecting a second recommended listing based on a second set of listings interacted with by the user, the second set of listings including the first listing;
causing the first recommended listing to be presented to the user; and
causing the second recommended listing to be presented to the user.
